(19) United States
(12) Patent Application Publication
(10) Pub. No.: US 2005/0263241 A1
(43) Pub. Date: Dec. 1, 2005

(54) Method and apparatus for folding the projecting end of a covering or decorative layer

(75) Inventors: Johann Lidicky, Scheffau (AT); Gerhard Windisch, Saalfelden (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: PRO.TE.X ENGINEERING GMBH

(21) Appl. No.: 11/136,360

(22) Filed: May 25, 2005

(30) Foreign Application Priority Data
May 27, 2004 (AT) A921/2004

(51) Int. Cl. B32B 31/20

(52) U.S. Cl. 156/216; 156/308.4; 156/475

(57) ABSTRACT

The invention relates to a method and apparatus for folding the projecting end of a covering or decorative layer over the edge of a supporting part, where at least the edge area of the supporting part is made of thermoplastic material and where at least one heatable punching element is provided, which can be applied to the folded-over end of the covering or decorative layer. The invention proposes that the projecting end of the covering or decorative layer be folded by a folding slide, which preferably is guided in a mold holding the supporting part, and which has openings or recesses for the passage of the at least one heatable punching element, which presses the covering or decorative layer at least point-wise into the edge area of the supporting part softened by the punching element.

### BACKGROUND OF THE INVENTION

The invention relates to a method and apparatus for folding the projecting end of a covering or decorative layer over the edge of a supporting part, where at least the edge area of the supporting part consists of thermoplastic material and where the folded-over end is pressed into the softening edge area of the supporting part by means of at least one heatable punching element.

Trim and lining parts, especially for the interior of automotive vehicles, e.g., dashboards, covers of glove compartments, linings of structural parts etc., usually are made of a dimensionally stable supporting part covered by a covering or decorative layer, for instance a textile lining or plastic sheeting. In order to lend an attractive appearance to the edges of such parts it is necessary to fold the covering or decorative material over the edge of the supporting part and to fasten it to the inner surface of the supporting part.

### DESCRIPTION OF PRIOR ART

Devices for folding over the decorative material are known in a large number of variants and usually consist of a mold for holding the supporting part during the trimming process, and a number of sliding elements for attaching the folded end of the decorative material on the inner surface of the supporting part.

Adherence of the folded-over end of the decorative material on the inner surface of the supporting part is achieved in many known cases by applying an adhesive on the periphery of the inner surface of the supporting part. The adhesives used are either contact adhesives or heat-activated adhesives. The latter are rendered adherent prior to the folding process by subjecting them to hot air or heat radiation, or they are activated through the folded end of the trim layer by the heated faces of the folding slide.

From DE 43 08 925 A1 a method and apparatus for the folding-over and fastening of the projecting ends of a covering material for interior lining parts of vehicles are known in which the adhesive is heated and thus activated by means of a hot air nozzle. Subsequently the covering material is folded over the edge and glued to the rear of the part.

The use of an adhesive has the disadvantage that the adhesive itself contributes to the cost of material and costly procedure steps are necessary for the clean and emission-free application of the adhesive. In this context DE 295 07 067 U1 has made known a device for the adhesive-free folding-over of covering materials on lining parts, in which the fastening of the folded-over border of the decorative material on the inner surface of the supporting part is achieved without an adhesive by partly melting, and thus rendering adhesive, the surface of the supporting part along the edge by means of hot air or an infrared radiation source. For this purpose the lining part is brought into the vicinity of the heating element by a moveable holder and is then lowered, and the projecting end of the decorative material is folded over by means of a folding slide, and the part is pressed against the folding slide to apply the necessary bonding pressure.

It is also known to fasten the folded-over border of the trim layer by means of ultrasonic welding. This incurs the disadvantage of relatively high cost of apparatus and considerable sound emission by the ultrasonic generator.

From EP 0 792 734 B1 a method and device for the manufacture of a molded part with a surface covered by a decorative material are known in which the molded part is made by laminate molding, i.e., by injecting a suitable plastic material onto the decorative material placed in the molding cavity. After the injection process the decorative material is fixed by pressing it into the still deformable molded part. The method is relatively costly, especially if trim parts with complicated exterior contours must be enfolded.

Finally a method and device for the folding-over of covering or decorative materials is known from DE 197 06 712 A1, in which a rotating tool is used that has an angular recess into which the free edge of a molded part together with the projecting end of decorative material projects. When the rotating tool is turned the projecting end is taken up and folded over onto the side of the molded part which is not covered by covering or decorative material. Due to the absence of counter pressure or a firm support of the molded part efficient pressing of the decorative material onto the back of the molded part is not possible. The projecting end of the covering or decorative material or the rotating tool may be heated prior to the fold-over operation in order to achieve better adhesion on the molded part.

From JP 62-211127 A and JP 10-202737 A methods and devices are known for folding-over the projecting end of a covering or decorative layer, in which the folded end is pressed into the softening edge area of a supporting part by means of a heatable punching element (see e.g. FIG. 4 of JP 62-211127 A).

From JP 10-202737 A there is known, additionally to a folding slide for the folding-over of the projecting end, a spring-loaded element, which is attached to the holder of the heatable punching element and by which the folded-over end of the decorative layer may still be held against the supporting part while the heatable punching element is already being lifted.

### SUMMARY OF THE INVENTION

It is the object of the present invention to propose improvements of known methods and devices for the adhesive-free folding-over of covering or decorative layers, which simplify the procedure and apparatus required while maintaining the quality standards of the finished product.

According to the invention this object is achieved by providing that the end of the covering or decorative layer be folded over and held in the position to be fixed by a folding slide, and that the at least one heatable punching element act on the covering or decorative layer through at least one opening or recess of the folding slide. Folding and fixing the covering or decorative layer thus requires only one part, i.e., the folding slide, while one or more heatable punching elements accurately act on the end of the decorative layer to be fixed, through the openings or recesses in the folding slide. In the method according to the invention folding-over of the end of the covering or decorative layer occurs in the unheated state with the heatable punching element ensuring secure attachment of the decorative layer in the edge area. In contrast to known procedures using hot air nozzles or infrared radiators, the quantity of heat which must be supplied for bonding may thus be applied point-wise with great precision.

In further development of the invention it is provided that the covering or decorative layer is penetrated by the heatable punching elements at least in partial areas. This will result in a particularly effective fastening.

According to the invention an apparatus for folding the projecting end of a covering or decorative layer over the edge area of a supporting part, where at least the edge area of the supporting part is made of thermoplastic material and where at least one heatable punching element is provided which can be applied to the folded end of the covering or decorative layer, is characterized in that for the folding of the projecting end of the covering or decorative layer a folding slide is provided, which preferably is guided in a mold holding the supporting part, and which has openings or recesses for the passage of at least one heatable punching element for pressing the covering or decorative layer at least point-wise into the edge area of the supporting part softened by the punching element.

According to the invention the heatable punching elements may have a structure on the their surface facing the covering or decorative layer, which penetrates the covering or decorative layer at least point-wise, for instance cone- or pyramid-shaped elevations. This will improve attachment of the covering or decorative layer on the supporting part.

### BRIEF DESCRIPTION OF THE DRAWING

The invention will be further described by way of example with reference to the accompanying drawings, in which

FIG. 1 shows in a schematic section an apparatus according to the invention for folding the projecting end of a covering or decorative layer over the edge of a supporting part in a first operating state;

FIGS. 2 and 3 show the apparatus of FIG. 1 in a second and third operating state;

FIG. 4 shows a detail of the apparatus of FIG. 1 in an oblique view.

### DETAILED DESCRIPTION OF THE PREFERRED EMBODIMENT

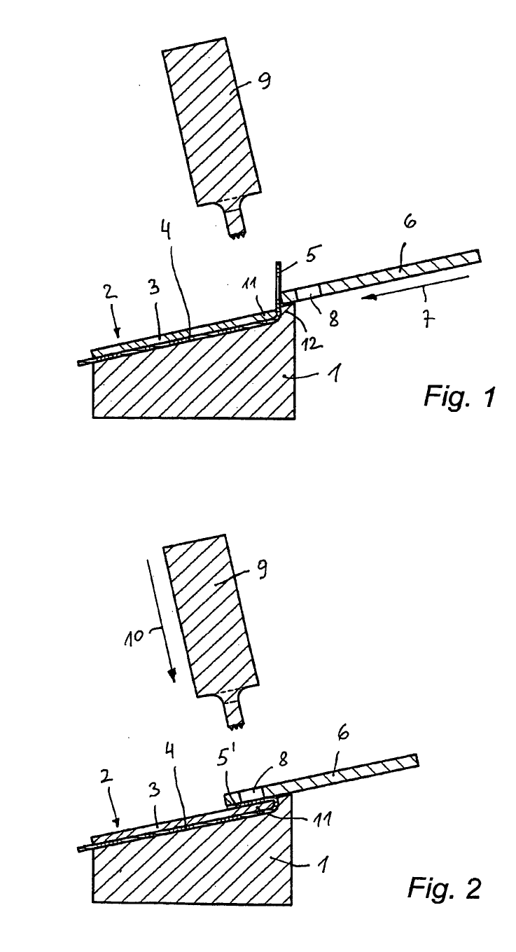

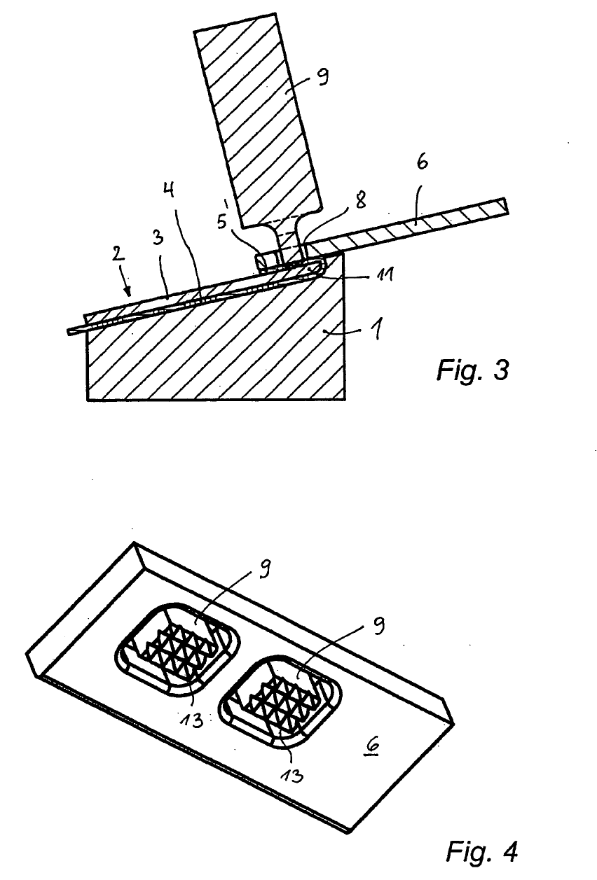

The apparatus presented in FIGS. 1 to 3 in different operational states shows in a mold 1 a lining element 2 comprising a supporting part 3 whose outer surface is covered by a covering or decorative layer 4 having a projecting end 5. The lining element 2 which is placed in the mold 1 for the folding-over process is held by means not further shown in the drawing, for instance by a partial vacuum generated between the mold 1 and the lining element 2. To fold the projecting end 5 of the covering or decorative layer 4 a folding slide 6 is provided, which is for instance guided in the mold 1 holding the lining element 2 and which by an advancing motion indicated by arrow 7 brings the end 5, which is lifted by a shoulder 12 of the mold 1, into a position shown in FIG. 2, in which the folded end 5′ of the covering or decorative layer 4 is held fixed by the folding slide 6. The folding slide 6 has openings or recesses 8 through which heatable punching elements 9 can be applied to the covering or decorative layer 4, or rather its folded end 5′. The advancing motion of the at least one heatable punching element 9 (see arrow 10) is essentially perpendicular to the surface of the edge area 11 of the supporting part 3, and the covering or decorative layer 4 is pressed at least point-wise into the edge area 11 of the supporting part 3, which area is being softened by the punching element 9.

To improve attachment of the covering or decorative layer 4 to the edge area of the supporting part 3 the heatable punching elements 9 are provided on their surface facing the covering or decorative layer 4, with a structure which penetrates the covering or decorative layer 4 at least point-wise. This structure may be a serrated pattern, as shown in FIG. 4, with conical or pyramidal elevations 13. The serrated pattern of the punching elements 9 transfers thermal energy through the covering or decorative material (for instance a textile weave) to the thermoplastic supporting part, thus welding the textile material and the supporting part together. A control unit, not shown, keeps the punching elements 9 at a constant temperature between 150° C. and 300° C., depending on the materials used. A plurality of punching elements 9 may be mounted on a guiding member and may be simultaneously applied on the lining part at a defined pressure.

1. (canceled)

2. (canceled)

3. (canceled)

4. (canceled)

5. (canceled)

6. A method for folding the projecting end of a covering or decorative layer over the edge of a supporting part, where at least the edge area of the supporting part consists of thermoplastic material, wherein the projecting end of the covering or decorative layer is folded over and held in a position to be fixed by a folding slide, wherein at least one heatable punching element acts on the covering or decorative layer through at least one opening or recess of the folding slide and wherein the folded-over end is pressed into the softening edge area of the supporting part by the at least one heatable punching element.

7. A method according to claim 6, wherein the covering or decorative layer is penetrated at least in partial areas by the at least one heatable punching element.

8. An apparatus for folding the projecting end of a covering or decorative layer over the edge area of a supporting part to form a folded-over end, where at least an edge area of the supporting part consists of thermoplastic material, wherein a folding slide is provided for the folding of the projecting end of the covering or decorative layer, which folding slide has openings or recesses for admitting at least one heatable punching element for pressing the folded-over end of the covering or decorative layer at least point-wise into the edge area of the supporting part softened by the heatable punching element.

9. An apparatus according to claim 8, wherein the folding slide is guided in a mold holding the supporting part.

10. An apparatus according to claim 8, wherein the heatable punching element comprises a surface facing the covering or decorative layer, having a structure which penetrates the covering or decorative layer at least point-wise.

11. An apparatus according to claim 10, wherein the structure on the surface of the punching elements facing the covering or decorative layer has a serrated pattern.

12. An apparatus according to claim 11, wherein the separated pattern comprises conical or pyramidal elevations.
